(19) United States
(12) Patent Application Publication
(10) Pub. No.: US 2003/0013418 A1
(43) Pub. Date: Jan. 16, 2003

(54) Portable communication apparatus

(76) Inventor: Shigeru Kato, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/182,515

(22) PCT Filed: Jan. 31, 2001
(86) PCT No.: PCT/JP01/00653

(51) Int. Cl. H04B 1/38

(52) U.S. Cl. 455/90; 455/575

(57) ABSTRACT

A portable communication apparatus has a casing body having improved resistance to shocks compared to the prior art. At least a part of a casing (2) of a portable communication apparatus (1) is made of a metal. When the casing (2) is made of a front casing member (4) and a back casing member (5), at least one of them is made of a metal. In this case, a circuit module (3) and the back casing member (5) are fixed by the same screws (8) to the front casing member (4).

### TECHNICAL FIELD

The present invention relates to portable communication apparatus and more particularly to such apparatus having improved resistance to shocks.

### BACKGROUND ART

Recently, portable communication apparatus such as portable radio telephones, portable radio data terminals and portable radio transceivers have diffused and used in various environments. They are required to have resistance to shocks that would suffer when they are dropped.

They have casings of plastic and their general shock-resisting structures include shock absorbers of soft rubber or plastic provided on upper and lower surfaces of plastic casings thereof.

In the case of the above-mentioned general casing structure, the shock absorbers may not completely absorb shocks that the apparatus will suffer, depending on an attitude of the apparatus taking when the same falls. When the portable communication apparatus drops, for example, taking an attitude in which its body extends horizontally, downward onto a horizontal hard floor or road and suffers a shock at its lower edge from the horizontal floor or road, the apparatus may be damaged or decomposed. Thus, they are required to have further improved resistance to shocks.

It is therefore an object of the present invention to provide a portable communication apparatus that has improved shock resistance compared to the prior art.

### DISCLOSURE OF INVENTION

In order to achieve the above object, the present invention provides a portable communication apparatus (1) comprising a casing (2) within which a circuit module (3) is housed, wherein: the casing comprises a plurality of casing members which include at least a front casing member (4) and a back casing member (5); and at least one of said plurality of casing members (4, 5) is made of a metal.

The front casing member may have a plurality of holes so that operation keys are exposed therethrough respectively. Since the holes weaken mechanical strength of the front casing, the front casing is preferably made of metal. In such arrangement, the casing and the apparatus have improved resistance to shocks.

When the casing member made of a metal comprises a side of the casing, the casing exhibits sufficient resistance to a shock directly given to the side of the casing.

The metal preferably includes a material of a high specific strength such as a magnesium alloy to reduce the weight of the apparatus.

When the casing comprises a front casing member (4) and a back casing member (5), and either the front casing member or back casing member is made of a metal, only the front casing member is preferably made of a metal, thus the portable communication apparatus may be light while having high resistance to shocks.

Further, when the front casing member is made of a metal, screwing means is preferably provided on the inner surface of the front casing member for screwing the circuit module and the back casing member on the inner surface of the front casing member. In this case, the circuit module and the back casing member are preferably screwed together.

In such arrangement, the apparatus casing has a further improved strength and an improved strength with which the circuit module is attached. Thus, even when apparatus receives shocks, the circuit module will not run wild within the casing to thereby destroy itself. Thus, the apparatus has further improved resistance to shocks.

The area where the plurality of holes for the like number of operation keys are formed preferably has an outer surface concave or in-curved such that when the apparatus is put on a flat surface with the outer surface of the front casing member facing the flat surface, the plurality of operation keys exposed respectively within the plurality of holes concerned are out of contact with the flat surface.

The portable communication apparatus preferably comprises an elastic shock absorber attached to an outer surface of the casing.

According to another aspect of the present invention, there is provided a portable communication apparatus comprising a casing within which a circuit module is housed, wherein: the casing comprises at least a front casing member and a back casing member; the circuit module comprises a rigid member screwed on at least one of the front and back casing members.

In this case, the rigid member is preferably screwed on the front casing member. The rigid member is preferably screwed along with the back casing member on the front casing member.

In such arrangement, the casing member on which the rigid member is screwed has a three-dimensional structure that is difficult to twist to thereby increase the mechanical strength of the apparatus casing. Also, the strength with which the circuit module is attached is increased. Thus, even when apparatus receives shocks, the circuit module will not run wild within the casing to thereby destroy itself. Thus, the apparatus has further improved resistance to shocks.

The number of male and female screws to be used for screwing purposes is reduced. Hence the number of parts to be used for assembling purposes and the number of assembling steps are reduced. This leads to cost reduction. The rigid member includes a conventional circuit board.

According to a further aspect of the present invention, there is provided a portable communication apparatus comprising a casing within which a circuit module is housed, wherein: the casing comprises at least a front casing member and a back casing member; and the back casing member is screwed on the front casing member.

In such arrangement, even when the apparatus suffers a shock, its front and back casing members are difficult to separate from each other, and the mechanical strength of the apparatus casing is improved.

When the back casing member is screwed along with the circuit module on the front casing member, the strength with which the circuit module is attached is improved. Thus, the apparatus has further improved resistance to shocks. The number of male and female screws to be used for assembling purposes and hence the number of parts and assembling steps to be also used for assembling purposes are reduced. This leads to cost reduction.

### BRIEF DESCRIPTION OF DRAWINGS

FIGS. 1A, 1B and 1C are side views, a plan view and another side view, respectively, of a portable communication apparatus as one embodiment of the present invention;

FIGS. 2A and 2B are front views and a side view, respectively, of a front casing member of the portable communication apparatus of FIGS. 1A, 1B and 1C;

FIGS. 3A and 3B are inside views and a side view, respectively, of a back casing member of the portable communication apparatus of FIGS. 1A, 1B and 1C;

FIG. 4 is a back side plan view of a partly decomposed internal circuit module of the communication apparatus of FIG. 1;

FIG. 5 is a side view of a partly decomposed internal circuit module of FIG. 4;

FIG. 6 is another side view of the internal circuit module of FIG. 4;

FIG. 7 is a front side plan view of the internal circuit structure of FIG. 4 from which several parts are removed away;

FIG. 8 schematically illustrates a cross-sectional view of an antenna of the communication apparatus of FIG. 1;

FIG. 9 is an enlarged view of an essential portion of FIG. 8;

FIG. 10 is a decomposed side view of the portable communication apparatus of FIG. 1; and

FIGS. 11A, 11B, 11C and 11D are front views, and different side views, respectively, viewed in the directions of B, C and D.

### BEST KODE FOR CARRING OUT THE INVENTION

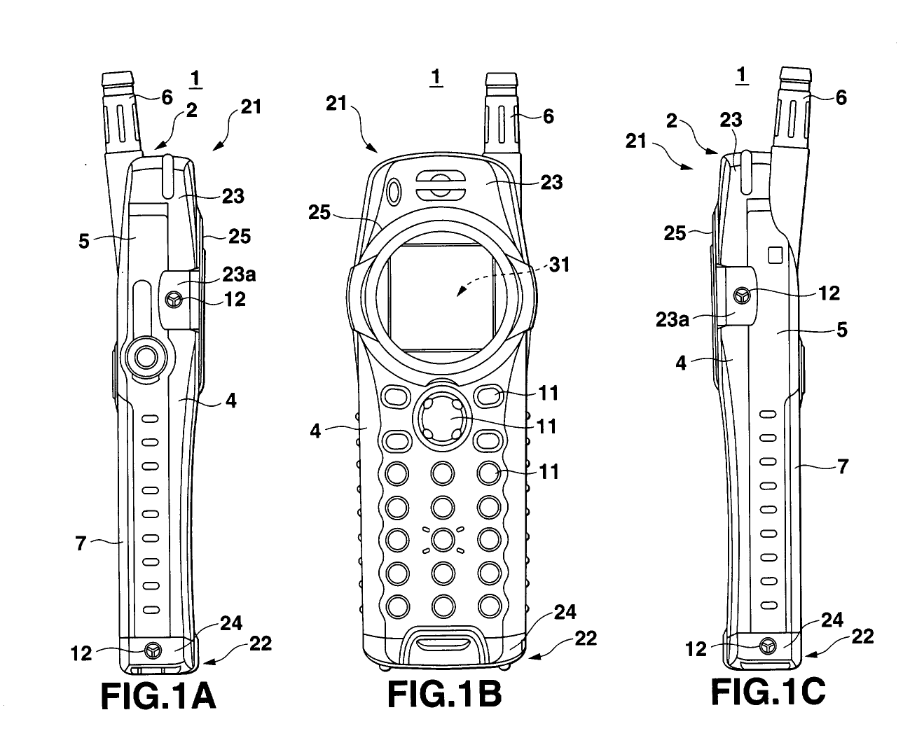

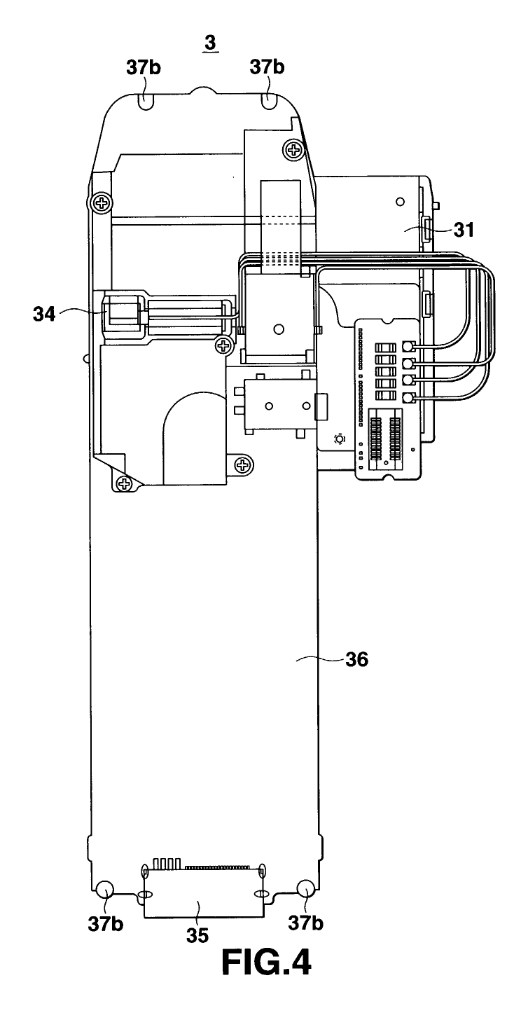

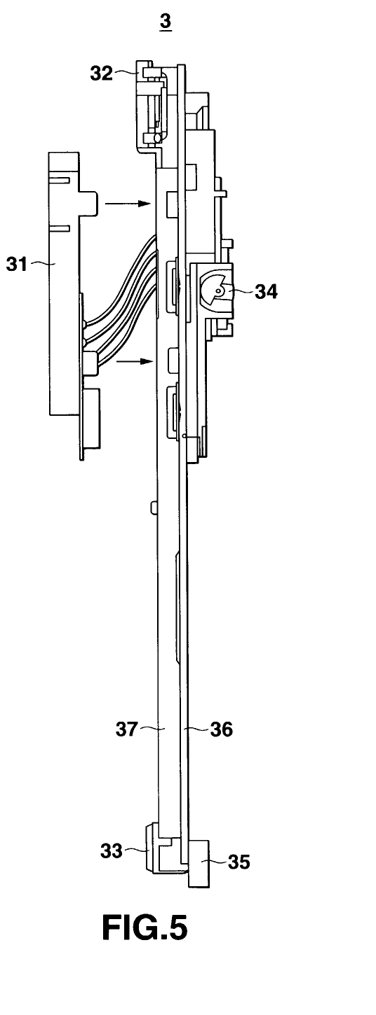

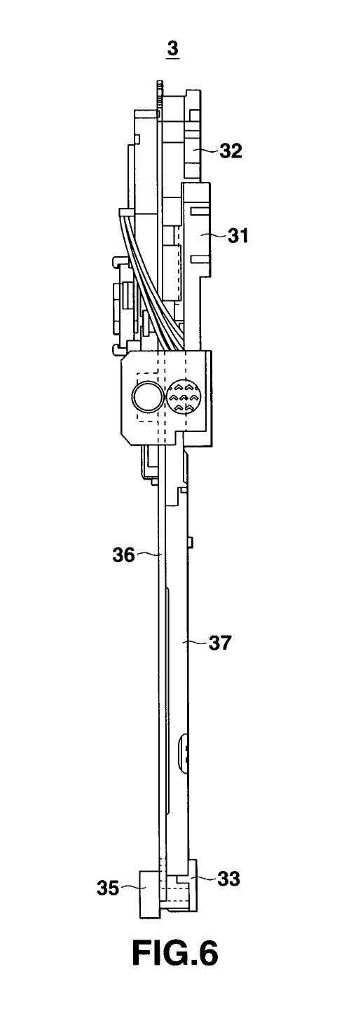

An embodiment of the present invention will be described in more detail with reference to the accompanying drawings. First, the structure of the embodiment will be described. As shown in FIGS. 1A, 1B and 1C, in a portable communication apparatus 1, a circuit module 3 (FIGS. 4-7) is provided within a casing 2 with a display device 31 and operation buttons 11 exposed from a surface of the casing 2. An antenna 6 that is electrically connected to the circuit module 3 is provided on top of the casing 2. A battery cover 7 or a battery integral with the battery cover is provided on the back of the casing 2. The upper and lower portions 21 and 22 of the casing 2 and the periphery of a protective glass cover 41a provided on the front of the casing 2 to protect the display device 31 are covered with shock absorbing materials of soft rubber or plastic 23, 24 and 25, respectively. The circuit module 3 is fixed on an internal surface of the casing 2.

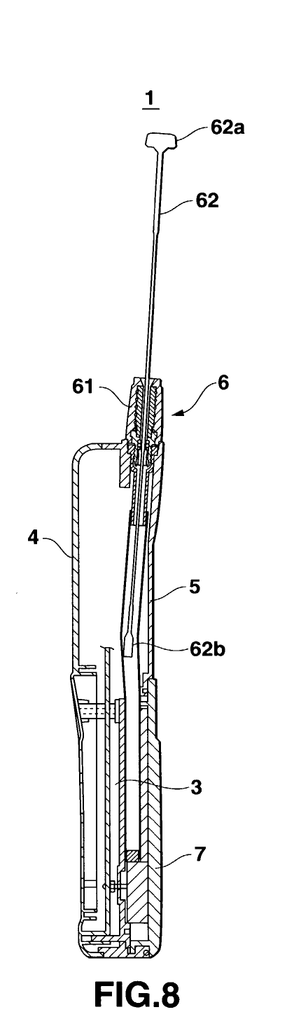

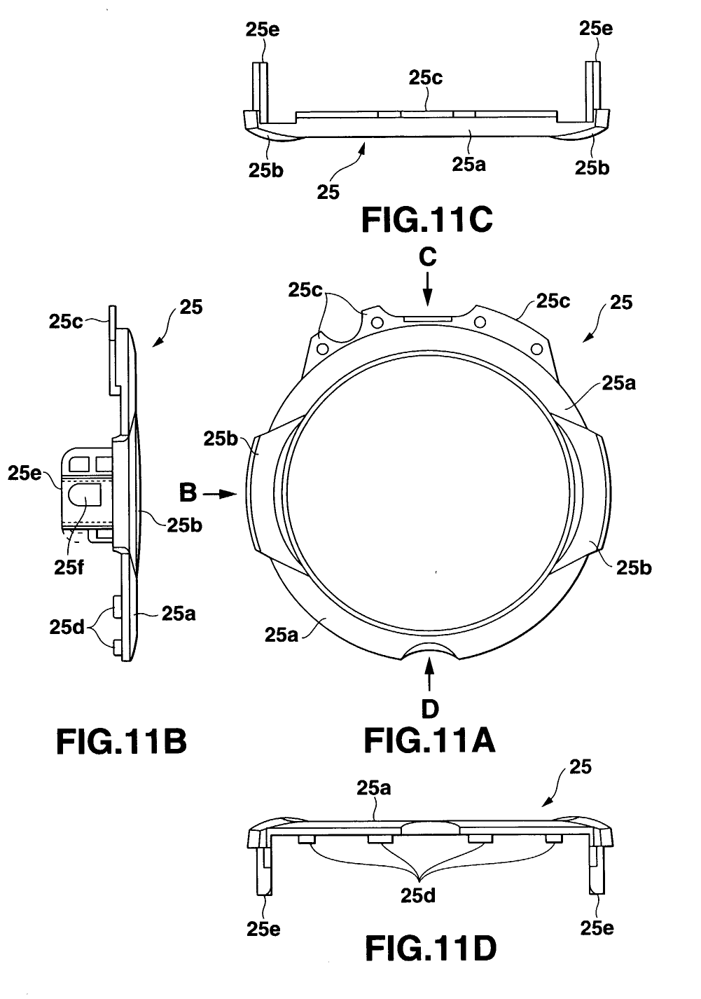

As shown in FIG. 11, the shock absorbing material 25 takes the form of a circular frame with a ring-like body 25a which covers the outer periphery of the protective glass cover 41a. The ring-like body 25a has an outer diameter larger than the width of a front casing member 4 (FIG. 8) so that the surface of the body 25a extends relative to the surface of the front casing member 4 and a curved surface of the protective glass cover 41a.

The body 25a includes a pair of opposite curved raises 25b which protrude slightly forward of the front thereof. The body 25a also includes contact pieces 25c provided on the back of the body 25a so as to extend upwards, a plurality of lower insertion tongues 25d which protrude toward the back of the body 25a, and a pair of opposite fixing pieces 25e protruding towards the back of the body 25a with each piece 25e having a fixing hole 25f.

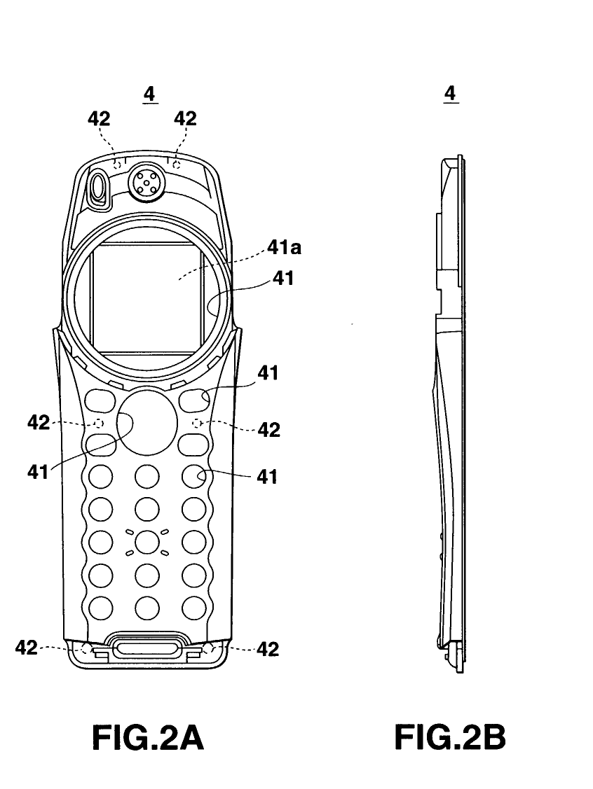

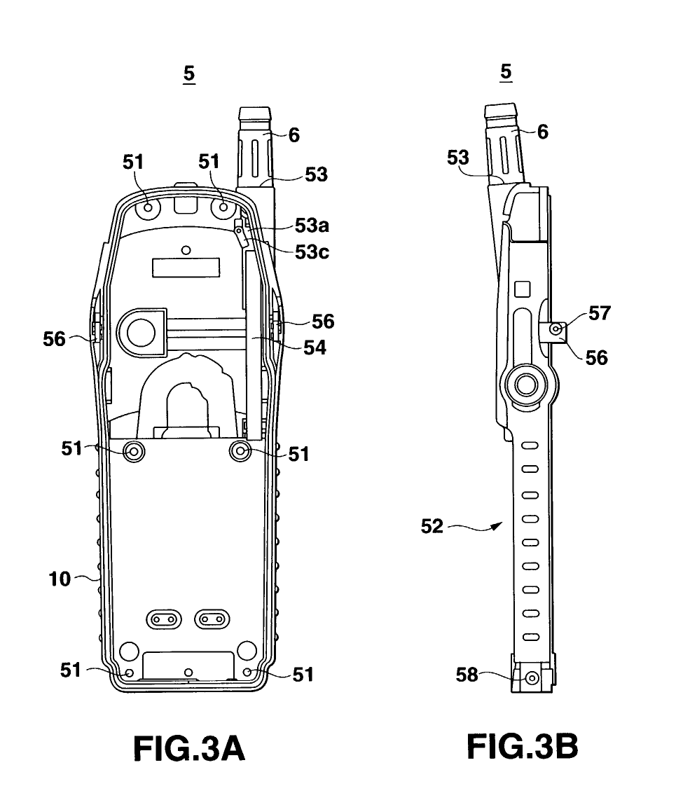

The casing 2 has a two-piece structure which comprises the front casing member 4 whose details are shown in FIGS. 2A and 2B and the back casing member 5 whose details are shown in FIGS. 3A and 3B.

The front casing member 4 is made of a metal having a high specific strength such as a magnesium alloy. The front casing member 4 has a plurality of through holes 41 through which the display device 31 and the operation buttons 11 are exposed respectively from the front side of the casing member 4. The through hole 41 for the display device 31 is covered with the protective glass cover 41a to protect the display device 31. The protective glass cover 41a is made, for example, of transparent plastic such as acrylic. As will be obvious from the side views of FIGS. 2B, 1A and 1C, an outer surface of an area of the front casing member 4 where the through holes 41 corresponding to the operation buttons 11 are formed is slightly concave or in-curved Thus, even when the front casing member 4 is put on a flat surface, for example, of a desk or floor with the outer surface of the front casing member 4 of the apparatus facing the flat surface of the desk or floor, the operation buttons 11 are not brought into contact with the flat surface of the desk or floor.

A pair of female screws 42 are provided in opposite side edge portions of each of an upper portion, a middle portion and a lower portion of the inner surface of the front casing member 4. The female screws 42 may be provided by tapping in protrusions formed on the internal surface of the front casing member 4. The female screws 42 do not reach the outer surface of the front casing member 4 to avoid damage to decorativeness of the apparatus casing.

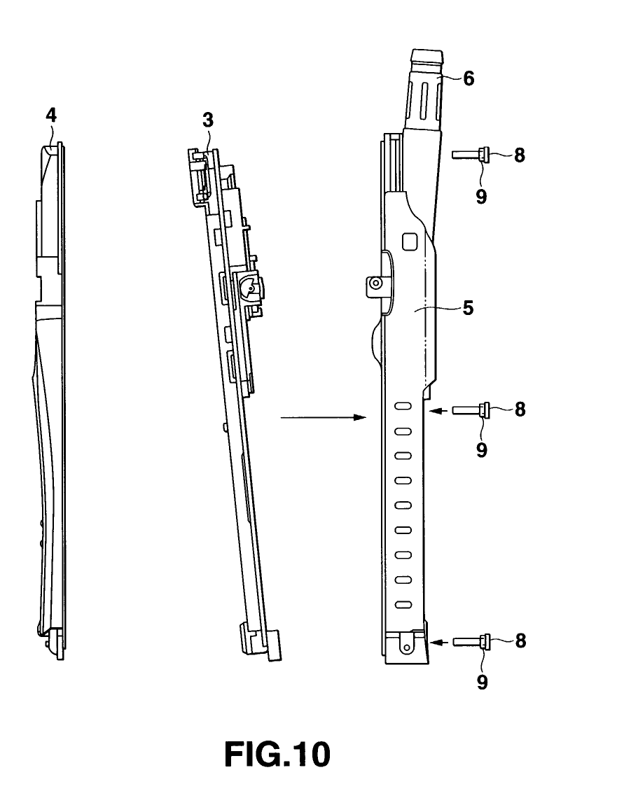

The back casing member 5 is made of a plastic material as in the prior art. A waterproof ring 10 is provided so as to extend around the outer periphery of a region where the front casing member 4 fits to the back casing member 5. The back casing member 5 has a pair of through holes 51 at positions corresponding to those of the pair of female screws 42 provided in each of the upper, middle and lower portions of the front casing member 4 with a pair of male screws 8 (FIG. 10) being engaged in the relevant pair of female screws 42 provided on the inner surface of the front casing member 4. A battery holder 52 is provided on a lower end portion of a back of the back casing member 5 to hold the batteries.

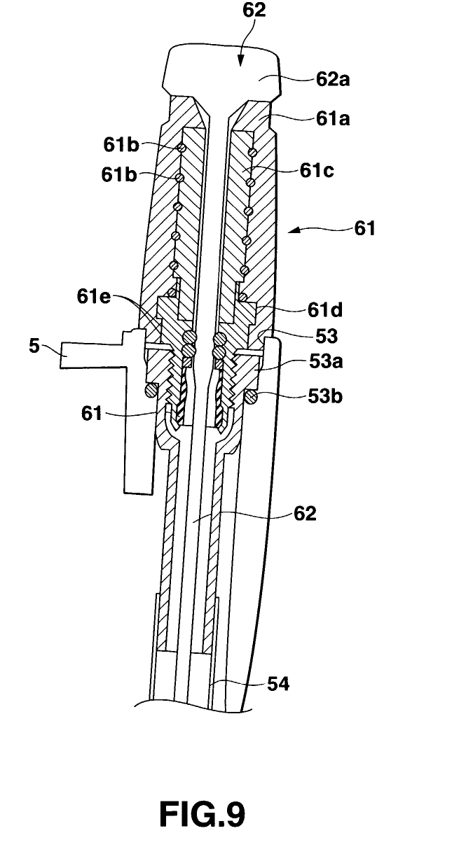

As shown in FIGS. 3A, 3B and 9, the back casing member 5 has a through hole 53 at its upper end into which a hollow metal cylinder 53a receiving an antenna 6 is press fitted through a waterproof ring 53b (FIG. 9). A hollow guide cylinder 54 is connected to a lower end portion of the metal cylinder 53a within the through hole 53. The guide cylinder 54 is made of a plastic material with an antenna element 62 (FIG. 9), which will be detailed later, being extensively housed within the guide cylinder 54.

The metal cylinder 53a is electrically connected to the antenna 6 and also in contact with a substantially V-like leaf spring connection terminal 53c provided on the back casing member 5. When the communication apparatus 1 is assembled, the connection terminal 53c is brought into contact with a terminal of the circuit module 3 positioned directly above the connection terminal 53c. Thus, the antenna 6 is brought into contact with the circuit module 3 through the metal cylinder 53a and the connection terminal 53c. FIG. 3 shows the back casing member 5 in which the antenna 6 is housed within the through hole 53.

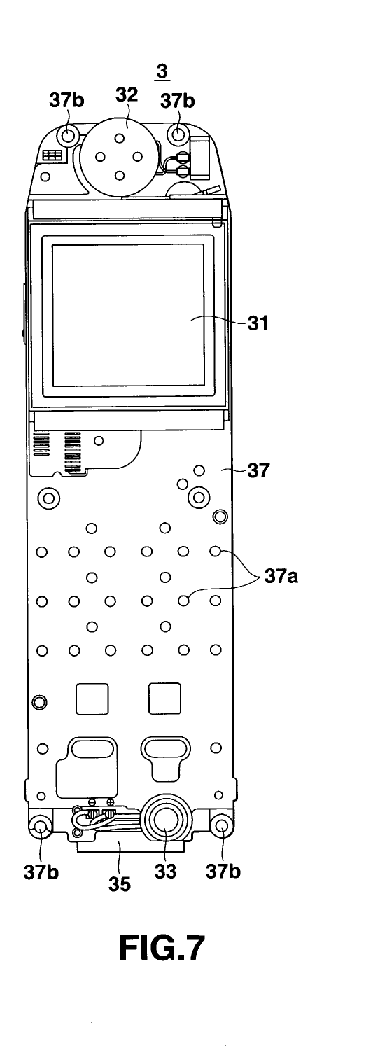

As shown in FIGS. 4-7, the circuit module 3 has a structure having a rigid substrate (electronic part holding member) 37 to which electronic parts of the apparatus such as a display unit 31, a speaker 32, a microphone 33, a vibrator unit 34, and a circuit substrate 36 on which an LSI and a connector 35 are mounted are fixed, for example, by screws. The substrate 37 is made of a metal having a high specific strength such as a magnesium alloy or fiberglass reinforced plastic (FRP). In order to reduce its weight while maintaining its strength, the substrate 37 has ribs extending along its sides. As shown in FIG. 7, the plate-like body of the circuit module 3 has a plurality of holes 37a. When the substrate 37 is made of FRP, a metal such as a nickel-copper alloy is evaporated or sputtered onto the substrate 37 to shield the substrate from electromagnetism or to allow static electric charges to escape. A keyboard or a keys-unit having a plurality of the operation buttons 11 are put on surface of an area of the substrate 37 where the plurality of holes 37a are formed.

The substrate 37 has a plurality of through holes 37b through which the corresponding screws 8 are engaged in the female screws 42 provided on the inner surface of the front casing member 4.

As shown in the cross-sectional view of FIG. 8, the antenna 6 is composed substantially of a fixed helical antenna unit 61 and an extendable antenna element 62 that is extendable through the helical antenna unit 61.

As shown in an enlarged view of FIG. 9, the helical antenna 61 comprises a hollow substantially cylindrical outer casing 61a of rubber or soft plastic and having an increased internal diameter at its lower end portion, a helical antenna element 61b provided on the internal surface of the outer casing 61a, a hollow substantially cylindrical inner casing 61c having a reduced outer diameter at its lower end inserted into the outer casing 61a, and a hollow substantially cylindrical metal male screw 61d driven inserted into the space between the lower ends of the outer and inner casings 61a and 61c. The male screw 61d is electrically connected at its upper end to the helical antenna element 61b. That is, the helical antenna 61 is fixed to the outside of the back casing member 5 by driving the male screw 61d into the female-screwed metal cylinder 53a. In this case, the antenna element 61b is electrically connected through the male screw 61d to the metal cylinder 53a and hence to the predetermined circuit of the circuit module 3.

The male screw 61d receives a plurality of O-like rings 61e which prevent moisture from entering the casing 2 and a conductive spring 61f which electrically connects between the metal cylinder 53a and the antenna element 62 in an inner hole. The plurality of O-like rings 61e are pressed through a washer by the conductive spring 61f, in the inner hole of the male screw 61d.

As shown in FIGS. 3 and 9, the antenna element 62 has a substantially rod-like stem portion having an outer diameter smaller than the inner diameter of the inner casing 61c so as to be extendable through the same. The antenna element 62 has an upper end portion 62a whose diameter is larger than the inner diameter of the outer casing 61a so that the antenna element 62 does not drop into the casing 2 through the helical antenna 61. The antenna element 62 has an upper thicker stem portion which is press fitted at a lower end into the O-like rings 61e. When the antenna element 62 is housed within the apparatus casing 2, as shown in FIG. 9, the stem portion is press fitted into the O-like rings 61e so as to prevent moisture from entering the casing 2 from the antenna 6.

The antenna element 62 has a lower thicker stem portion which is press fitted at a lower end into the O-like rings 61e and a lower end portion 62b whose outer diameter is larger than the inner diameter of the inner casing 61c. When the antenna element 62 is extended to its maximum extent, the lower end portion 62b of the antenna element 62 contacts with the inner surface of the conductive spring 61f and prevents the antenna element 62 from being drawn out off the apparatus casing 2. Thereby the antenna element 62 is electrically connected to the predetermined circuit of the circuit module 3 through the conductive spring 61f, the male screw 61d, the metal cylinder 53a and the connection terminal 53c. Also, when the antenna element 62 is extended to its maximum extent, the lower thicker stem portion of the antenna element 62 is press fitted into the O-like rings 61e so as to prevent moisture from entering the apparatus casing 2 from the antenna 6.

The antenna element 62 is coated with an insulation material excluding its upper and lower end portions 62a and 62b. Thus, only when the antenna element 62 is drawn out from the casing 2 such that its lower end portion 62b is brought into contact with the conductive spring 61f, the antenna element 62 acts as an antenna. Otherwise, the antenna element is not brought into electrical contact with the conductive spring 61f.

Referring to FIG. 10, a process for assembling the portable communication apparatus 1 will be described. First, the circuit module 3 is inserted into the back casing member 5 in which the antenna 6 is already provided. In this case, the circuit module 3 and the back casing member 5 are placed so that their through holes 37b and 51 align. Next, the keyboard is attached to the circuit module 3. Then, the front and back casing members 4 and 5 are aligned and screws 8 are driven through the through holes 51 and 37b into the female screws 42 to fix the circuit module 3 and the back casing member 5 to the front casing member 4 to thereby assemble the casing 2. The O-like rings 9 on the screws 8 serve to prevent moisture from entering the corresponding female screws and also to prevent the screws 8 from being loosened.

The shock absorber 25 is then fitted over the front of the casing 2. In this case, the shock absorber 25 is fitted over the front casing member 4 so that the fixing pieces 25e fit over the outsides of the fixing pieces 56 of the back casing member 5.

Then, the upper and lower shock absorbers 23 and 24 are fitted over the casing 2 and fixed by screws. In this case, right and left extensions 23a of the upper shock absorber 23 fit over the corresponding outsides of the fixing pieces 25e. As shown in FIG. 1, the male screws 12 are then inserted and driven through the extensions 23a and fixing holes 25f in the fixing pieces 25e into female screws 57 provided in the fixing pieces 56 of the back casing member 5. Thus, the shock absorbers 23 and 25 are fixed to casing 2. Now, the shock absorber 24 is fitted over a lower end portion of the casing 2. Then screws 12 are driven into the female screws 58 provided in the back casing member 5 to fix the shock absorber 24 to the casing 2.

Batteries are then set within the casing 2 and finally the battery cover 7 is attached to the casino, 2 to thereby complete assembling of the communication apparatus 1.

If the batteries are rechargeable from recharging terminals provided on an outer surface of the back casing member 5 or the battery cover 7, the shock absorber 24 may be arranged so as to cover the lower end portion of the battery cover 7. In this case, batteries are set in position and the battery cover 7 is attached in position. Then the shock absorber 24 is fitted over the lower end of the casing 2 and similarly fixed by screws to thereby complete the assembling of the communication apparatus 1. This further improves a strength with which the battery cover 7 is attached to the casing 2.

In the portable communication apparatus 1, thus obtained, has the front casing member 4 of a metal. Thus, even when the casing 2 receives shocks on its side, it exhibits increased resistance to the shocks compared to the prior art.

Since the female screws 42 are formed in the metal casing, the reliability and durability of engagement of the male screws 7 with the corresponding female screws 42 are improved. Thus, decomposition and composition of the communication apparatus can be performed without minding the durability of engagement of the male and female screws.

Since electronic parts such as the display device 31f or use in the portable communication apparatus 1 are fixed to the substrate 37 to provide the circuit module 3, which is then fixed along with the back casing member 5 by screws 8 to the front casing member 4. Thus, even when shocks are applied to the apparatus 1, the electronic parts will not run wild within the casing 2 to destroy the apparatus 1 and the back casing member 5 will not come off the front casing member 4. Thus, the portable communication apparatus 1 has further improved resistance to shocks.

Since the vibrator unit 34 is fixed by the screws to the substrate 37, which is in turn fixed by the screws to the metal front casing member 4, vibrations of the vibrator unit 34 are transmitted well to the casing when actuated.

Since the circuit module 3 and the back casing member 5 are fixed by the same screws 8 to the front casing member 4, the number of parts to be used for assembling purposes, the number of assembling steps, the cost and the whole apparatus weight are reduced.

The synergistic effect of the fact that the upper and lower portions of the casing 2 and the periphery of the display window are covered with the shock absorbers 23, 24 and 25, and the fact that the front casing member 4 is made of a metal gives the apparatus 1 increased resistance to shocks applied externally to the apparatus, especially from above, below or its front side.

Since the antenna element 61b is fixed to the outside of the casing 2, the antenna gain is maintained at a high value in spite of the front casing member 4 being made of a metal.

The antenna functions only when the antenna element 62 is drawn out as an auxiliary antenna from the casing 2 or when the antenna element can only effectively function as such. Thus, the whole gain of the antenna 6 including the antenna element 62 is maintained at a high value in spite of the front casing member 4 being made of a metal. Thus, the sensitivity of the apparatus 1 is maintained at a high value.

While in the embodiment the front casing member 4 is illustrated as being formed of a metal, the present invention is not limited to this particular case. Only the back casing member 5 may be formed of a metal or both of the front and back casings members 4 and 5 or the whole casing 2 may be formed of a metal.

Even when the casing 2 has no two-piece structure but is made of more pieces, a part or all of the pieces may be made of a metal to achieve advantages similar to those produced by the above embodiment.

While in the embodiment the rigid substrate 37 and the circuit substrate 36 are different from each other, the rigid substrate 37 may, consist of the circuit substrate 36 by making the circuit substrate 36 of fiberglass reinforced plastic (FRP).

If necessary, the circuit module 3 and the back casing member 5 may be fixed by separate screws to the front casing member 4.

According to the present invention, a portable communication apparatus (1) comprises a casing (2) within which a circuit module (3) is housed, wherein: the casing comprises at least a front casing member (4) and a back casing member (5); and at least one of the front and back casing members (4) and (5) is made of a metal. Alternatively, the circuit module (3) may be screwed on an inner surface of at least one of the front and back casing members. Alternatively, the back casing member (5) may be screwed on an inner surface of the front casing member (4); or all those steps may be used together, to greatly improve the resistance of the apparatus and hence its casing to a shock.

1. A portable communication apparatus comprising a casing (2) within which a circuit module (3) is housed, wherein:
said casing comprises a plurality of casing members which include at least a front casing member (4) and a back casing member(5); and
at least one of said plurality of casing members (4,5) is made of a metal.

2. The portable communication apparatus according to claim 1, wherein:
said front casing member has a plurality of holes so that operation keys are exposed therethrough respectively, and said front casing member is made of the metal.

3. The portable communication apparatus according to claim 2, wherein:
said front casing member has screwing means provided on an inner surface thereof for screwing the circuit module on the inner surface thereof.

4. The portable communication apparatus according to claim 2, wherein:
said front casing member has screwing means provided on an inner surface thereof for screwing said back casing member on the inner surface thereof.

5. The portable communication apparatus according to claim 4, wherein:
the circuit module is screwed along with said back casing member on the inner surface of said front casing member.

6. The portable communication apparatus according to any one of claims 2-5, wherein:
said front casing member has an area where the plurality of holes for the like number of operation keys are formed, said area having an outer surface concave such that when the apparatus is put on a flat surface with the outer surface of said front casing member being in contact with the flat surface, the like number of operation keys exposed respectively within the plurality of holes concerned are out of contact with the flat surface.

7. The portable communication apparatus according to any one of claims 1-6, wherein:
said metal comprises a magnesium alloy.

8. The portable communication apparatus according to any one of claims 1-7, comprising:
an elastic shock absorber attached to an outer surface of said casing.

9. The portable communication apparatus according to claim 8, wherein:
said elastic shock absorber attached to a periphery of a display window of an outer surface of said casing.

10. A portable communication apparatus comprising a casing within which a circuit module is housed, wherein:
said casing comprises at least a front casing member and a back casing member;
the circuit module comprises electronic elements provided on a rigid member for composing a circuit;
said rigid member being screwed on at least one of said front and back casing members.

11. The portable communication apparatus according to claim 10, wherein:
said rigid member is screwed on said front casing member.

12. The portable communication apparatus according to claim 10, wherein:
said rigid member is screwed along with said back casing member on said front casing member.

13. A portable communication apparatus comprising a casing within which a circuit module is housed, wherein:
said casing comprises at least a front casing member and a back casing member; and
said back casing member is screwed on said front casing member.

14. The portable communication apparatus according to claim 13, wherein:
said back casing member is screwed along with the circuit module on said front casing member.
